(19) United States
(12) Patent Application Publication
(10) Pub. No.: US 2024/0025088 A1
(43) Pub. Date: Jan. 25, 2024

(54) A FORMER HOLDER WITH A QUICK-RELEASE MECHANISM FOR USE IN LATEX GLOVE DIPPING PROCESS

(71) Applicant: Kong Wai CHEE, Selangor Dami Ehsan (MY)

(72) Inventor: Kong Wai CHEE, Selangor Dami Ehsan (MY)

(21) Appl. No.: 17/756,128

(22) PCT Filed: Dec. 10, 2019
(86) PCT No.: PCT/MY2019/000048

§ 371 Date: May 18, 2022

(30) Foreign Application Priority Data
Feb. 28, 2019 (MY) PI2019001090

(51) Int. Cl. B29C 41/40; B29C 41/14; B29C 33/30

(52) U.S. Cl. CPC B29C 41/40; B29C 41/14; B29C 33/305; B29L 2031/4864

(57) ABSTRACT

A former holder with a quick-release mechanism for use in latex glove dipping process. A locking mechanism between the former and the holder is provided for enhancing efficiency and performance of the latex glove dipping process. One of the advantages of a former holder with a quick-release mechanism for use in latex glove dipping processes is that the former can be easily removed and replaced from the holder without disruption of the glove manufacturing operation. Furthermore, the attachment between the former and holder is a centralized position which reduces dislodged problems due to vibration, misalignment of the former when passing the stripping machine and avoids an uneven dipping process in a latex dipping tank and a coagulant dipping tank. In addition, the holder with the quick-release mechanism can be easily fitted to an automatic former replacement machine to reduce manpower and safety during replacement.

### FIELD OF THE INVENTION

The present invention relates to a former holder with a quick-release mechanism for use in latex glove dipping process. More particularly, the present invention relates to a locking mechanism between the former and the holder for enhancing efficiency and performance of latex glove dipping process.

### BACKGROUND OF THE INVENTION

A former holder assembly for use in latex glove dipping process such as in glove manufacturing industry generally includes a former attached and detached to a holder with a locking mechanism. The former is typically carried by conveyor chain through the former holder for latex glove dipping process. However, the existing former holder assembly suffers from a number of disadvantages, as the process of installation or replacement of the former can be extremely cumbersome and time consuming during the glove manufacturing process. The installation or replacement of the former from the holder requires substantial precise engagement to enable smooth locking and unlocking of the former during operation wherein there is a must of an alignment to perform locking and unlocking operations.

PCT application, PCT/MY2017/050004 (published as WO2017131508) disclosed a former holder locking mechanism for use in latex dipping industry as illustrated in FIG. 1. Accordingly, the former holder locking mechanism includes: a) a shaft collaboratively in communication with holder; b) a cam unit having an active cam and a passive cam to perform locking and unlocking operations; c) active and passive biasing elements collaboratively work with the active and passive cams to securely urge a former into tight engagement with the cavity of the holder; d) retaining plate configured in adjacent with locking protrusion of the active cam; wherein each active cam and the passive cam is provided with predefined cam pathway, such that they are able to collaboratively reciprocate in accordance with the locking and unlocking positions; and wherein the active and passive biasing elements enable to provide sufficient opposite forces to urge the cam unit, such that to enable the active and passive cams to be securely travelled along their predefined cam pathway as turning motion is being applied for locking or unlocking operations. However, such locking mechanism is too relying on the active and passive cams to securely urge a former into tight engagement with the cavity of the holder which does not provide sufficient force to retain the former and could be easily disengaged during operations. In some occasions, this may lead to damage or broken former which may unintentional lead to an injury or harm to the operators.

In view of the above shortcomings, the present invention aims to provide a new design for a practical and effective former holder system for rapid, easy and safe installation or replacement of the former. Accordingly, the present invention aims to provide an improved former holder locking mechanism for use in latex glove dipping industry, one which in more simple and effective approaches, and yet robust and durable in use. The present invention also facilitates ready and easy attaching and detaching the former, while at a same time provides safe and effective locking and unlocking operations.

### SUMMARY OF THE INVENTION

The present invention provides a former holder for use in latex glove dipping process comprising a holder having a roller disc coupled with an indexing cap, a hollow shaft connected to an arm structure at one end and extended to the roller disc at another end, a spring positioned around the hollow shaft; characterized in that; a former having a male connector, a female receptor positioned circumference the hollow shaft of the holder, such that a quick-release mechanism configured for attaching a former to a holder and detaching the former from the holder via a locking mechanism between the male connector of the former and the female receptor of the hollow shaft.

A quick-release mechanism method of attaching a former to a holder and detaching the former from the holder for use in latex glove dipping process of the present invention comprising providing a male connector of a former; providing a female receptor positioned circumference of a hollow shaft of the holder; pushing the male connector of the former to the female receptor positioned circumference of a hollow shaft of the holder for attaching the former to the holder via a locking mechanism; pressing the female receptor positioned of the hollow shaft of the holder towards a direction of the male connector of the former; and pulling the male connector of the former from an opposite direction of the female receptor positioned circumference of a hollow shaft of the holder for detaching the former from the holder.

One of the advantages of a former holder with a quick-release mechanism for use in latex glove dipping process of the present invention, it can be easily removed and replaced the former from the holder without disruption of the glove manufacturing operation. Furthermore, the attachment between the former and holder with this invention is a centralized position which reduces dislodged problem due to vibrate, misalignment of the former when passing the stripping machine and to avoid uneven dipping process in latex dipping tank and coagulant dipping tank. In addition, the holder with the quick-release mechanism can be easily fitted to an automatic former replacement machine to reduce manpower and safety during replacement.

Further advantages of the system in accordance with the invention and its application can be derived from the description and the accompanying drawings. The above-mentioned features and those to be further described below can be utilized in accordance with the invention individually or collectively in arbitrary combination. The embodiments mentioned are not to be considered exhaustive enumerations, rather have exemplary character. The invention is shown in the drawings and explained more closely with reference to embodiments.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 illustrates a prior art of the former holder.

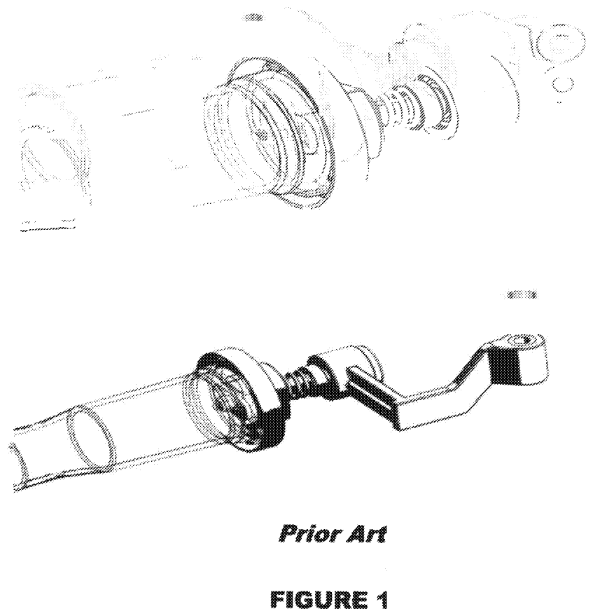

FIG. 2A illustrates a male connector of the former in accordance of a first embodiment of the present invention.

FIG. 2B illustrates a cross sectional view of a male connector of the former in accordance of the first embodiment of the present invention.

FIG. 2C illustrates an exploded view of a male connector of the former in accordance of the first embodiment of the present invention.

FIG. 2D illustrates a male connector of the former in accordance of a second embodiment of the present invention.

FIG. 2E illustrates a male connector of the former in accordance of a third embodiment of the present invention.

FIG. 3A illustrates an exploded view of a first embodiment of a female receptor positioned circumference the hollow shaft of the holder in accordance of the present invention.

FIG. 3B illustrates a quick-release mechanism configured for attaching a former to a holder and detaching the former from the holder via a ball and sleeve locking mechanism in accordance of the present invention.

FIG. 3C illustrates a sectional view of a quick-release mechanism configured for attaching a former to a holder via a ball and sleeve locking mechanism in accordance of the present invention.

FIG. 3D illustrates a close-up view of a quick-release mechanism configured for attaching a former to a holder via a ball and sleeve locking mechanism in accordance of the present invention.

FIG. 4A illustrates an exploded view of a second embodiment of a female receptor positioned circumference the hollow shaft of the holder in accordance of the present invention.

FIG. 4B illustrates a cross-sectional view of a second embodiment of a female receptor positioned circumference the hollow shaft of the holder in accordance of the present invention.

FIG. 4C illustrates a quick-release mechanism configured for attaching a former to a holder and detaching the former from the holder via a spring and post detent locking mechanism in accordance of the present invention.

FIG. 4D illustrates a close-up view of a quick-release mechanism configured for attaching a former to a holder via a spring and post detent locking mechanism in accordance of the present invention.

FIG. 5A illustrates an exploded view of a third embodiment of a female receptor positioned circumference the hollow shaft of the holder in accordance of the present invention.

FIG. 5B illustrates a cross-sectional view of a third embodiment of a female receptor positioned circumference the hollow shaft of the holder in accordance of the present invention.

FIG. 5C illustrates a quick-release mechanism configured for attaching a former to a holder and detaching the former from the holder via a clip and post detent locking mechanism in accordance of the present invention.

FIG. 5D illustrates a close-up view of a quick-release mechanism configured for attaching a former to a holder via a clip and post detent locking mechanism in accordance of the present invention.

FIG. 6A illustrates an exploded view of a fourth embodiment of a female receptor positioned circumference the hollow shaft of the holder in accordance of the present invention.

FIG. 6B illustrates a perspective view of a fourth embodiment of a female receptor positioned circumference the hollow shaft of the holder in accordance of the present invention.

FIG. 6C illustrates a cross-sectional view of a fourth embodiment of a female receptor positioned circumference the hollow shaft of the holder in accordance of the present invention.

FIG. 6D illustrates a quick-release mechanism configured for attaching a former to a holder and detaching the former from the holder via a core and key locking mechanism in accordance of the present invention.

FIG. 6E illustrates a close-up view of a quick-release mechanism configured for attaching a former to a holder via a core and key locking mechanism in accordance of the present invention.

### DETAILED DESCRIPTIONS OF THE INVENTION

The present invention will now be described in detail in connection with specific embodiments with reference to the accompanying drawings. Unless the context requires otherwise, throughout the specification and claims which follow, the word “comprise” and variations thereof, such as, “comprises” and “comprising” are to be construed in an open, inclusive sense that is as “including, but not limited to”. Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Various aspects of the systems and devices disclosed herein may be illustrated by describing components that are connected, coupled, attached, bonded and/or joined together. As used herein, the terms “connected”, “coupled”, “attached”, “bonded” and/or “joined” are used interchangeably to indicate either a direct connection between two components or, where appropriate, an indirect connection to one another through intervening or intermediate components. Additionally, unless otherwise specified, these terms are used interchangeably to indicate a connection in which one or more degrees of freedom are not rigidly constrained between two components (e.g., a pivoting connection, a translating connection, a pivoting and translating connection, an elastic connection, a flexible connection, etc.), or a rigid or substantially rigid connection in which all degrees of freedom are constrained or substantially constrained between the two components.

The terms “left,” “right,” “top,” “bottom,” “front,” “rear,” “side,” “height,” “length,” “width,” “upper,” “lower,” “interior,” “exterior,” “inner,” “outer” and the like as may be used herein, merely describe points or portions of reference and do not limit the present invention to any particular orientation or configuration. Further, terms such as “first,” “second,” “third,” etc., merely identify one of a number of portions, components and/or points of reference as disclosed herein, and do not limit the present invention to any particular configuration or orientation.

The present invention relates to a former holder with a quick-release mechanism for use in latex glove dipping process. Hereinafter, this specification will describe the present invention according to the preferred exemplary or embodiments of the present invention. However, it is to be understood that limiting the description to the preferred exemplary or embodiments of the invention is merely to facilitate discussion of the present invention and it is envisioned that those skilled in the art may devise various modifications and equivalents without departing from the scope of the appended claims.

The present invention aims to provide a practical and effective former holder system for rapid, easy and safe installation or replacement of the former. Accordingly, the present invention provides a former holder with a quick-release mechanism for use in latex glove dipping process, one which will be more simple and effective approaches, and yet robust and durable in use. The former holder locking mechanism for use in latex glove dipping process according to the preferred exemplary of the present invention will now be described in accordance to the accompanying drawings

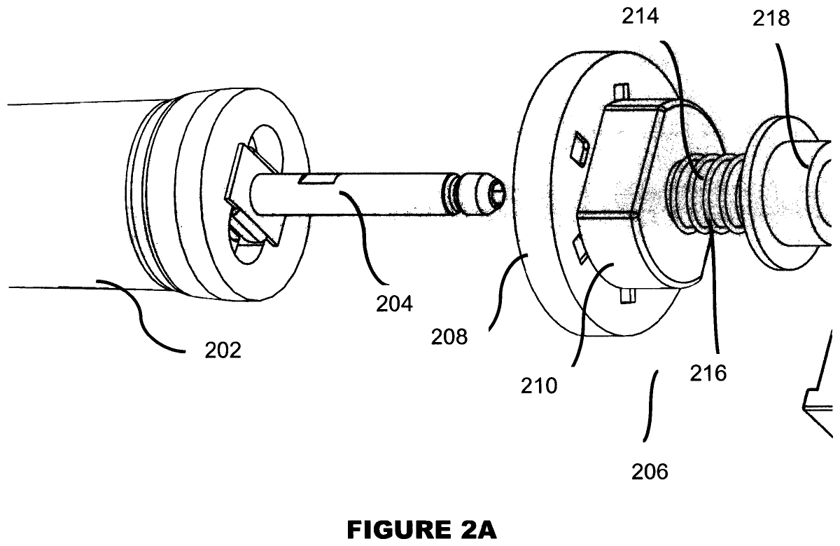

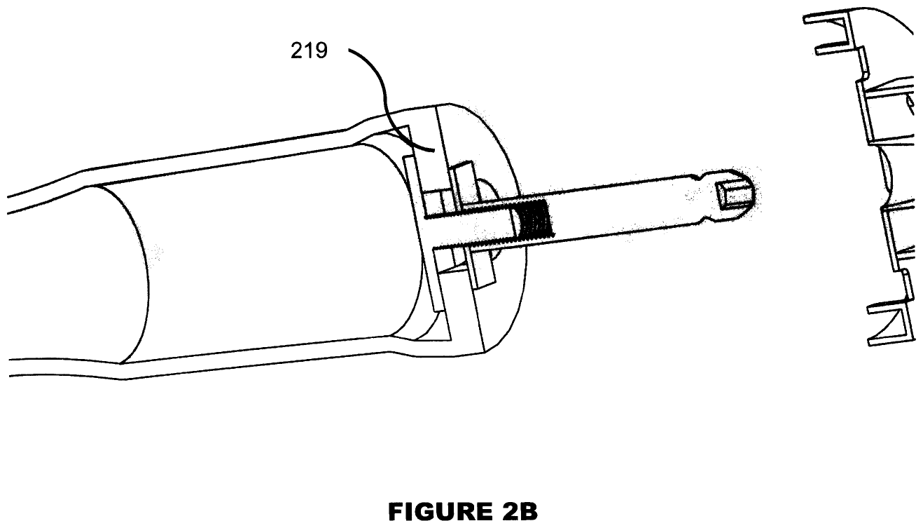

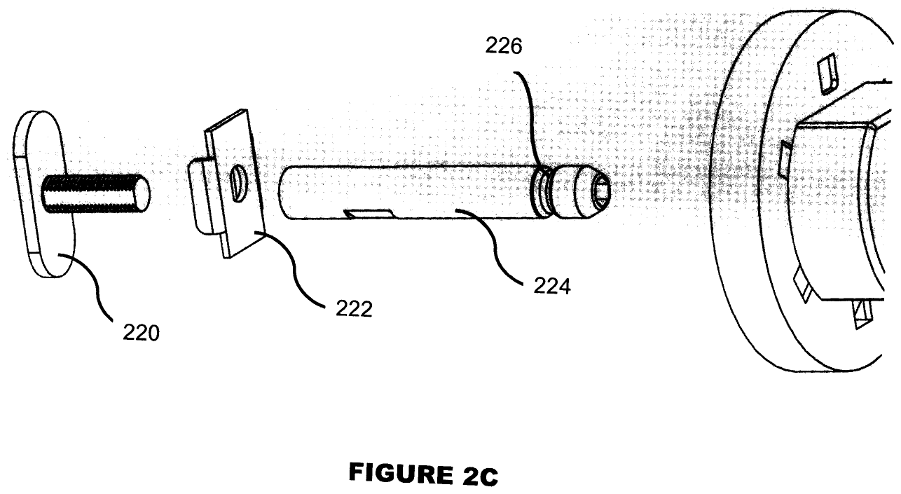

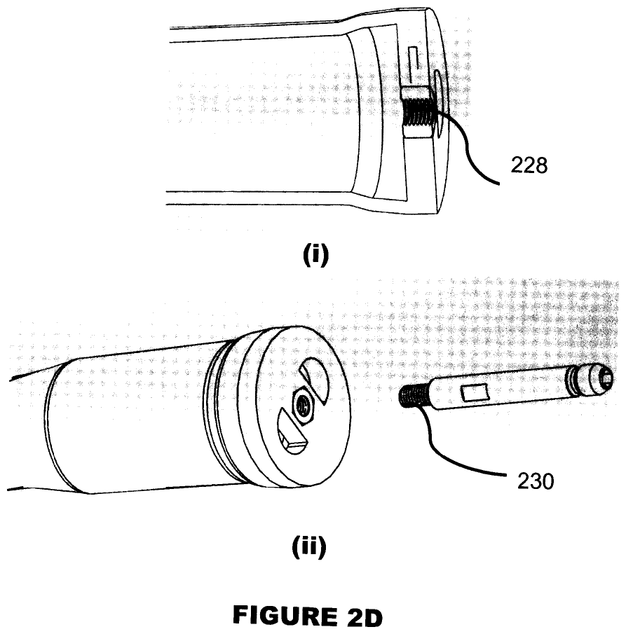

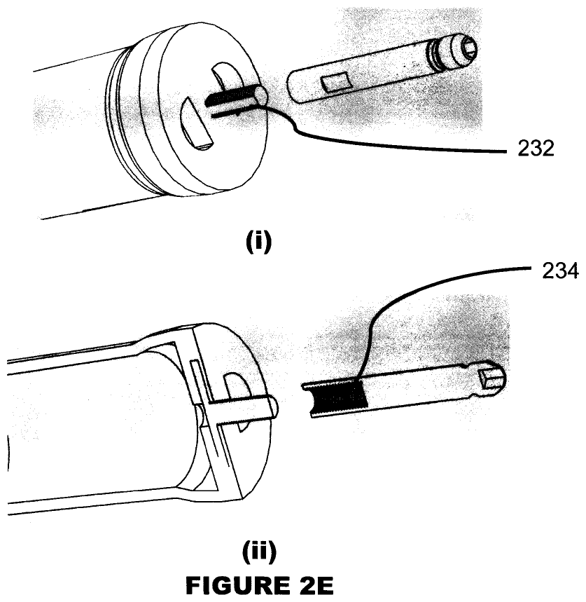

FIG. 2A illustrates a male connector (204) of the former (202) in accordance of the present invention. A former holder (202,206) for use in latex glove dipping process comprising a holder (206) having a roller disc (208) coupled with an indexing cap (210), a hollow shaft (214) connected to an arm structure at one end and extended to the roller disc (208) at another end, a spring (216) positioned around the hollow shaft (214), a female receptor (218) for engage and disengage with a former (202) having a male connector (204). FIG. 2B illustrates a cross sectional view of a male connector of the former in accordance of the present invention. The male connector is an extended elongated shaft from an end cuff portion (219) of the former. It is preferred that the male connector is molded in one-piece with the former. FIG. 2C illustrates an exploded view of a male connector of the former in accordance of the present invention. Alternatively, the male connector is securely attached to the end cuff portion of the former via a retention plate with threaded screw mate (220) and engage to an elongated shaft (222) via another retention plate (224) or any equivalent attachment means. It is preferably that the male connector has a circumference groove (226) near an end of the male connector of the former to allow securely engaged and disengaged to the female receptor positioned circumference the hollow shaft of the holder.

FIG. 2D illustrates a male connector of the former in accordance of a second embodiment of the present invention. The former of this embodiment having a prefabricated nut (228) positioned at the centre of an end cuff portion of the former. This allows the male connector subsequently to be fastened preferably a threaded fastener (230) to the former into one-piece former prior to securely engage and disengage to the female receptor positioned circumference the hollow shaft of the holder. FIG. 2E illustrates a male connector of the former in accordance of a third embodiment of the present invention. It is preferably that the male connector is securely attached to the end cuff portion of the former via a casting bolt (232) into the former. This allows the male connector subsequently to be fastened preferably a hollow internally threaded shaft (234) to the former into one-piece former prior to securely engage and disengage to the female receptor positioned circumference the hollow shaft of the holder. Depending on the application, the male connector and the female receptor of the present invention are made from materials selected cast iron, stainless steel, thermoplastics and other materials which could withstand high temperature during latex glove dipping process.

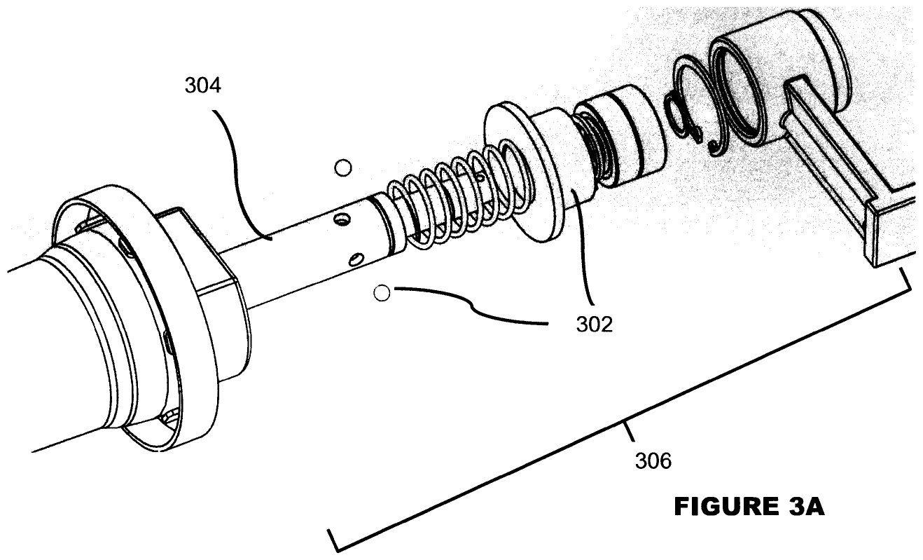

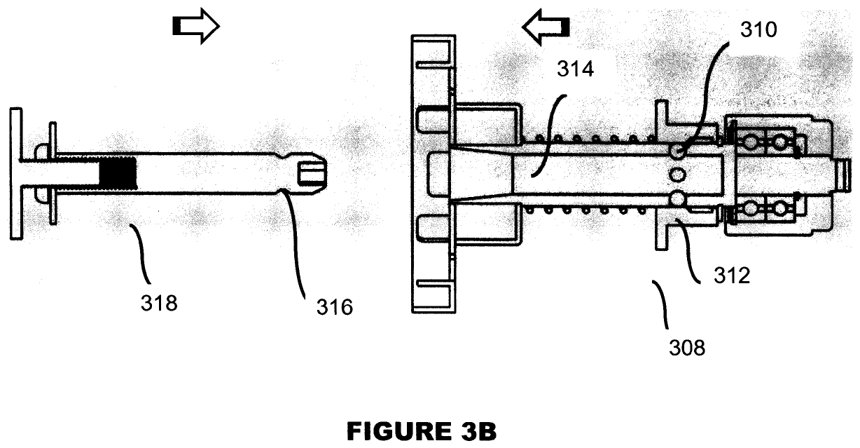

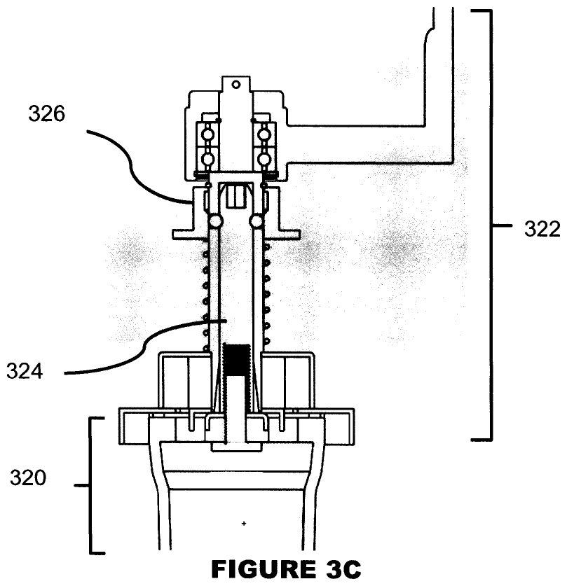

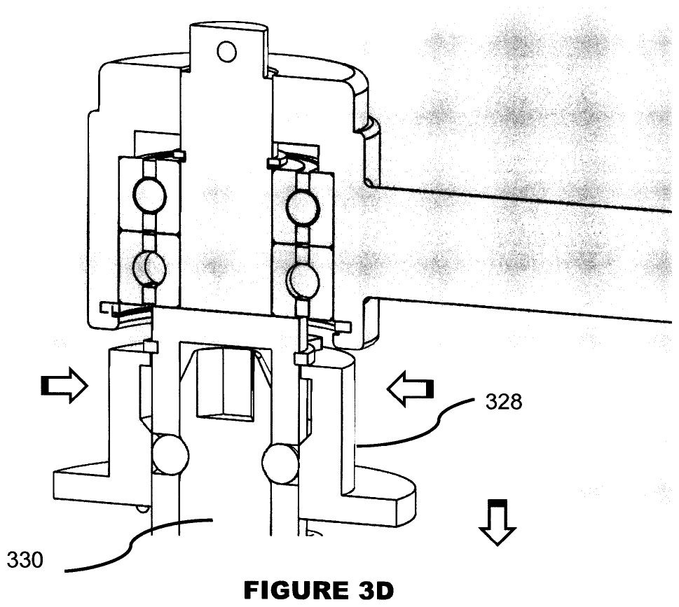

FIG. 3A illustrates an exploded view of a first embodiment of a female receptor positioned circumference the hollow shaft of the holder in accordance of the present invention. The female receptor (302) positioned circumference the hollow shaft (304) of the holder (306). A quick-release mechanism is configured for attaching a former to a holder and detaching the former from the holder via a locking mechanism between the male connector of the former and the female receptor of the hollow shaft. FIG. 3B illustrates a quick-release mechanism configured for attaching a former to a holder (308) and detaching the former from the holder (308) via a ball (310) and sleeve locking mechanism in accordance of the present invention. It is preferably that the female receptor (312) is a housing with at least one ball (310) circumference attached to the hollow shaft (314) allowing a circumference groove (316) near an end of the male connector (318) of the former securely engaged and disengaged to the female receptor (312) positioned circumference the hollow shaft (314) of the holder (308). Preferably the ball is made from steel, plastic or any equivalent materials withstand high pressure and high temperature.

FIG. 3C illustrates a sectional view of a quick-release mechanism configured for attaching a former (320) to a holder (322) via a ball and sleeve locking mechanism in accordance of the present invention. The male connector (324) is fitted securely to the female receptor (326) into one unit of former holder for latex glove dipping process. FIG. 3D illustrates a close-up view of a quick-release mechanism configured for attaching a former to a holder via a ball and sleeve locking mechanism in accordance of the present invention. To detach the former from the holder, force is exerted by pressing the female receptor (328) positioned of the hollow shaft of the holder towards a direction of the male connector (330) of the former. Subsequently, the male connector (330) of the former is pull from an opposite direction of the female receptor (328) positioned circumference of a hollow shaft of the holder for detaching the former from the holder. In the event the present invention is used in the production of latex gloves through dipping process, the formers used are in the shape of a hand. Depending on needs and requirements, formers of required shapes will be used in the production of condoms, balloons and others by those persons skilled in the art familiar with the latex glove dipping process. In production of latex products, the formers are required to go through a series of processes guided by the guiding track in the production line to produce the final products at a certain speed. The selection of the speed depends on the stability of the processing line to produce latex products of international standard quality.

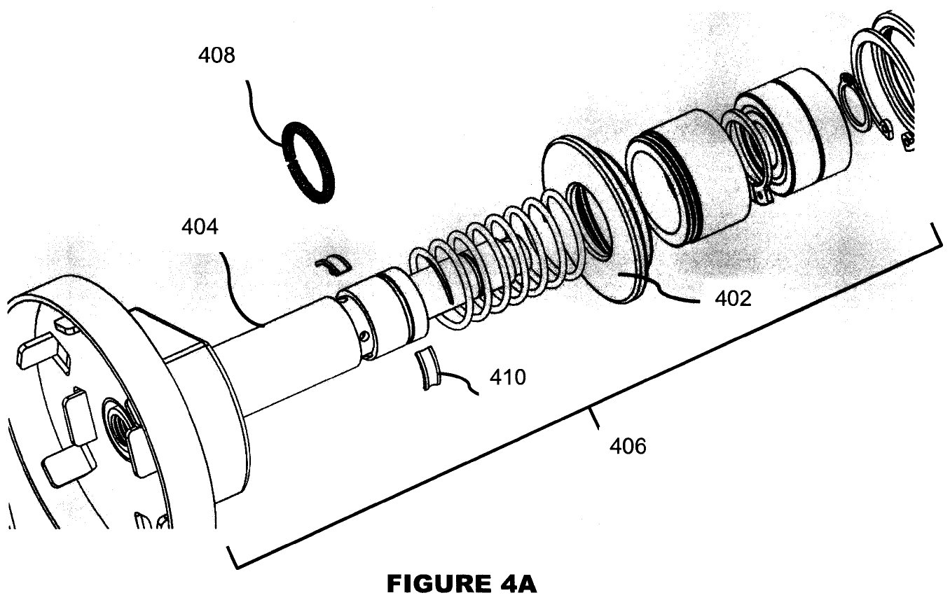

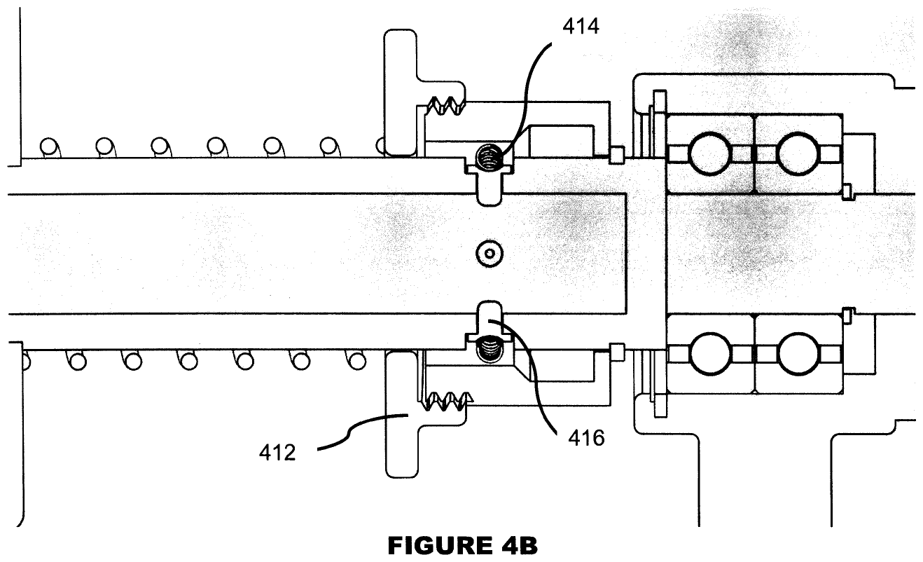

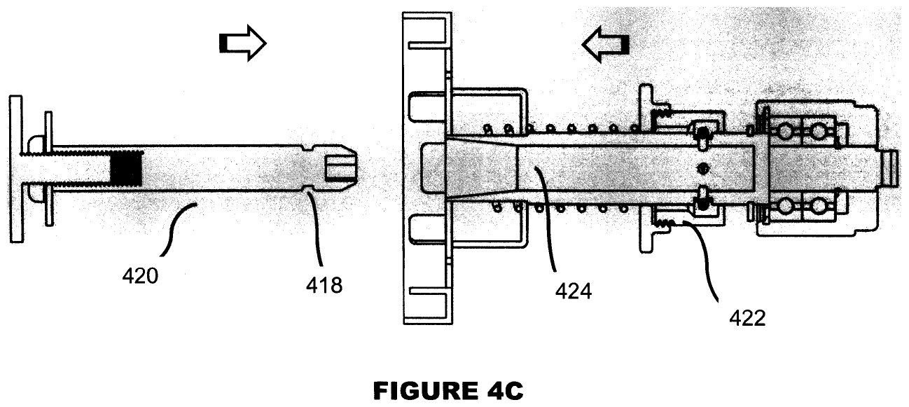

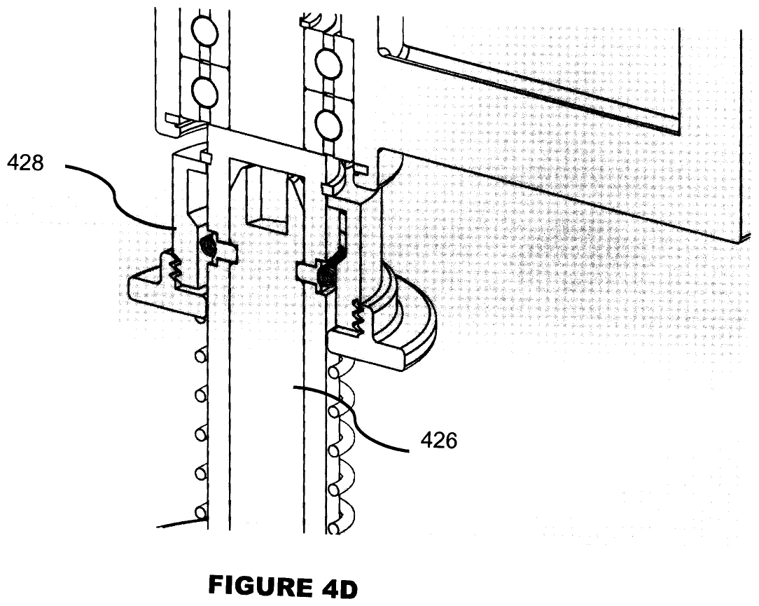

FIG. 4A illustrates an exploded view of a second embodiment of a female receptor (402) positioned circumference the hollow shaft (404) of the holder (406) in accordance of the present invention. It is preferably that the female receptor (402) is a housing with a spring (408) and at least one curve pin (410) circumference attached to the hollow shaft (404). FIG. 4B illustrates a cross-sectional view of a second embodiment of a female receptor positioned circumference the hollow shaft of the holder in accordance of the present invention. The arrangement of the female receptor such that the housing (412) having the spring (414) and the curve pins (416) to form a spring and post detent locking mechanism.

FIG. 4C illustrates a quick-release mechanism configured for attaching a former to a holder and detaching the former from the holder via the spring and post detent locking mechanism in accordance of the present invention. A circumference groove (418) near an end of the male connector (420) of the former is securely engaged and disengaged to the female receptor (422) positioned circumference the hollow shaft (424) of the holder via a spring and post detent locking mechanism. FIG. 4D illustrates a close-up view of a quick-release mechanism configured for attaching a former to a holder via a spring and post detent locking mechanism in accordance of the present invention. To attach the former to the holder, the male connector (426) of the former is pushed to the female receptor (428) positioned circumference of a hollow shaft of the holder for attaching the former to the holder via a locking mechanism. Meanwhile, to detach the former from the holder, force is exerted by pressing the female receptor (428) positioned of the hollow shaft of the holder towards a direction of the male connector (426) of the former. Subsequently, the male connector (426) of the former is pull from an opposite direction of the female receptor (428) positioned circumference of a hollow shaft of the holder for detaching the former from the holder.

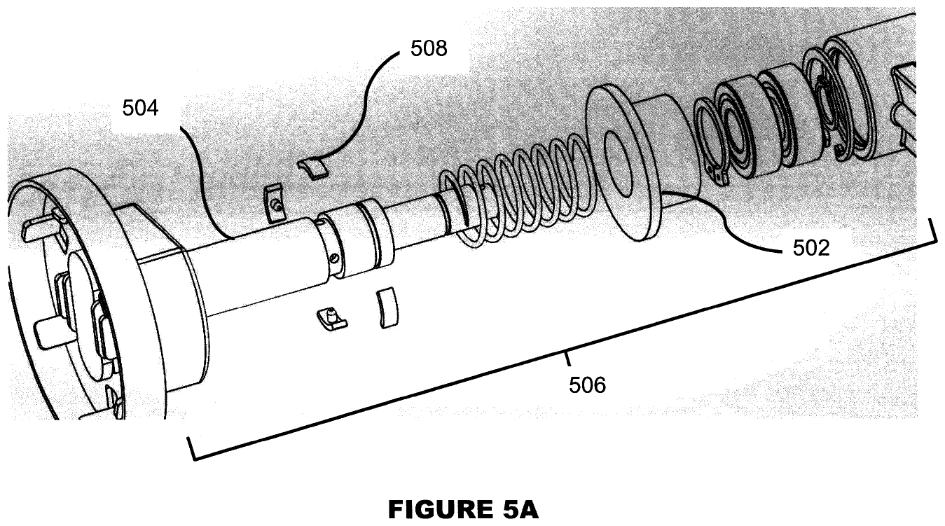

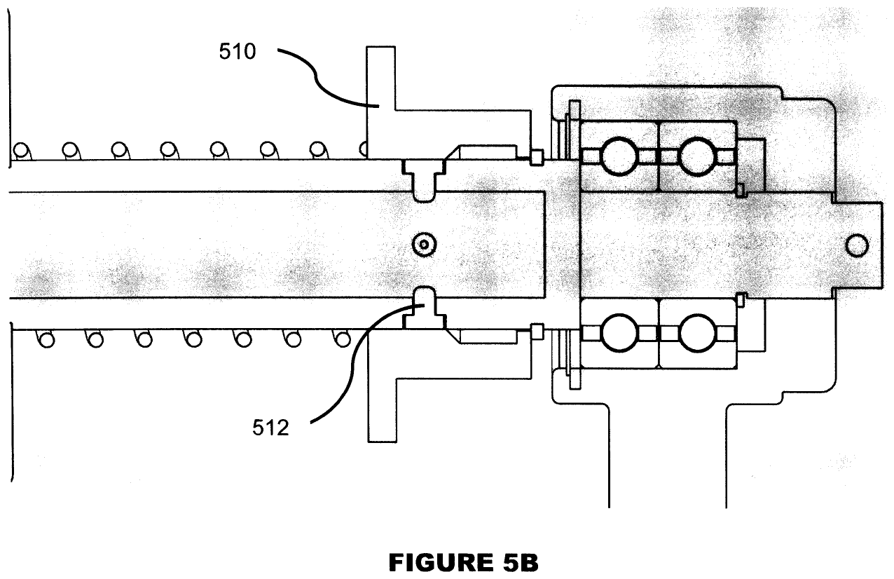

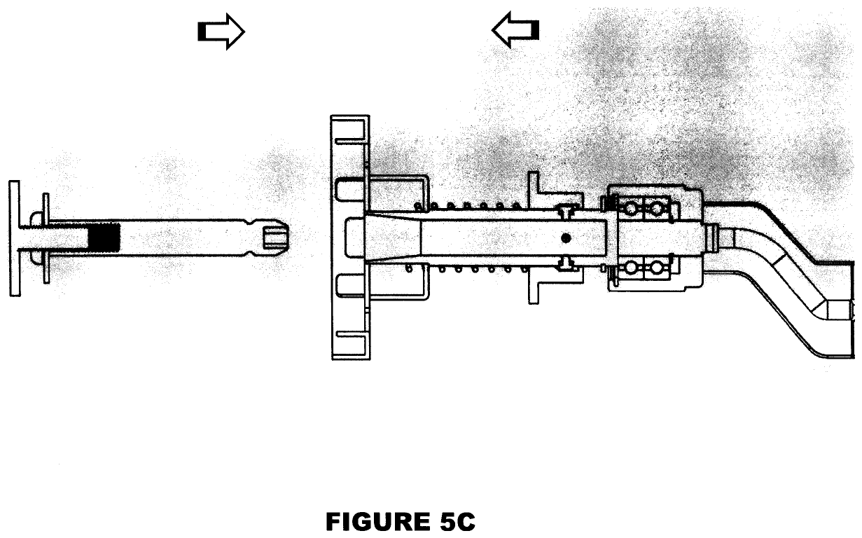

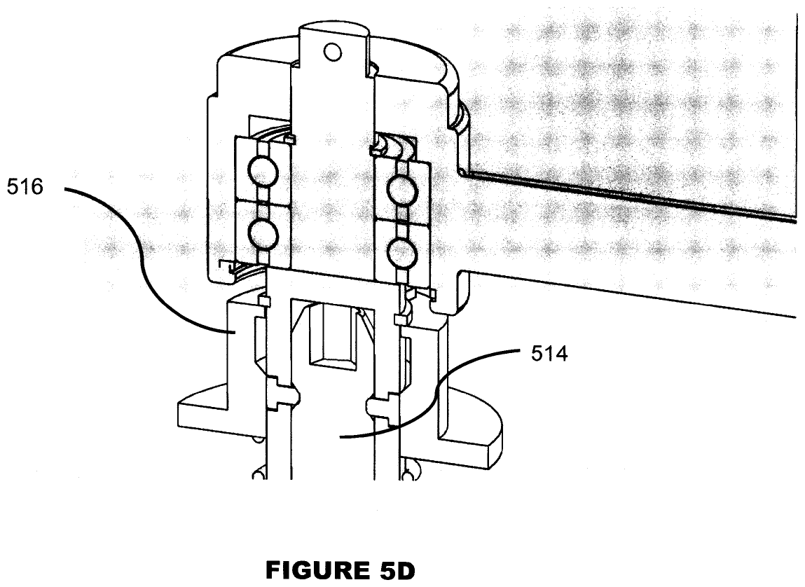

FIG. 5A illustrates an exploded view of a third embodiment of a female receptor (502) is positioned circumference the hollow shaft (504) of the holder (506) is a housing having at least one curve pin (508) circumference attached to the hollow shaft (504). FIG. 5B illustrates a cross-sectional view of a third embodiment of a female receptor positioned circumference the hollow shaft of the holder in accordance of the present invention. The arrangement of the female receptor such that the housing (510) having the curve pins (512) is snap-fitted to form a clip and post detent locking mechanism. FIG. 5C illustrates a quick-release mechanism configured for attaching a former to a holder and detaching the former from the holder via a clip and post detent locking mechanism in accordance of the present invention. A circumference groove near an end of the male connector of the former is securely engaged and disengaged to the female receptor positioned circumference the hollow shaft of the holder via a clip and post detent locking mechanism. FIG. 5D illustrates a close-up view of a quick-release mechanism configured for attaching a former to a holder via a clip and post detent locking mechanism in accordance of the present invention. To attach the former to the holder, the male connector (514) of the former is pushed to the female receptor (516) positioned circumference of a hollow shaft of the holder for attaching the former to the holder via a locking mechanism. Meanwhile, to detach the former from the holder, force is exerted by pressing the female receptor (516) positioned of the hollow shaft of the holder towards a direction of the male connector (514) of the former. Subsequently, the male connector (514) of the former is pull from an opposite direction of the female receptor (516) positioned circumference of a hollow shaft of the holder for detaching the former from the holder.

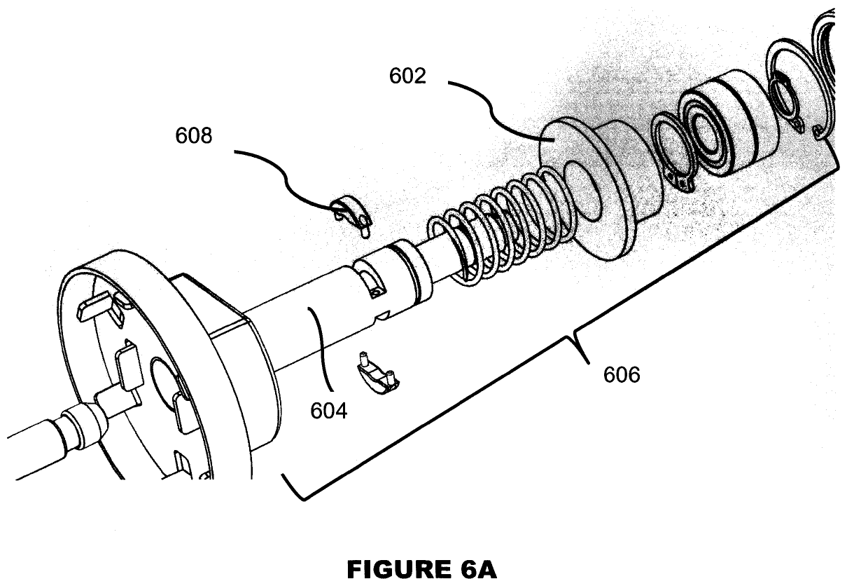

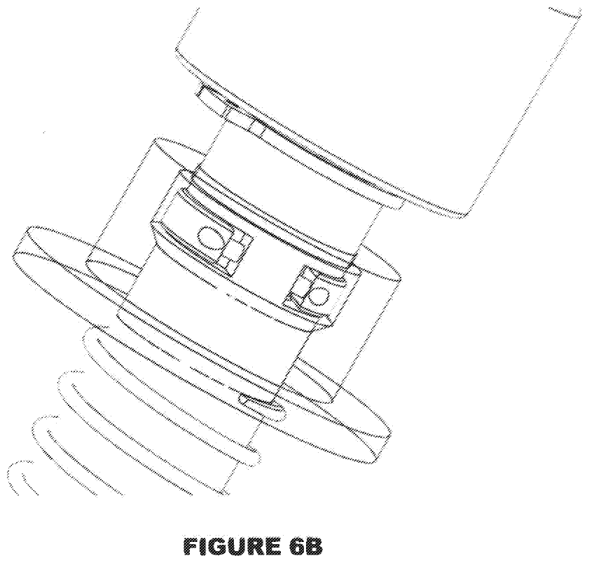

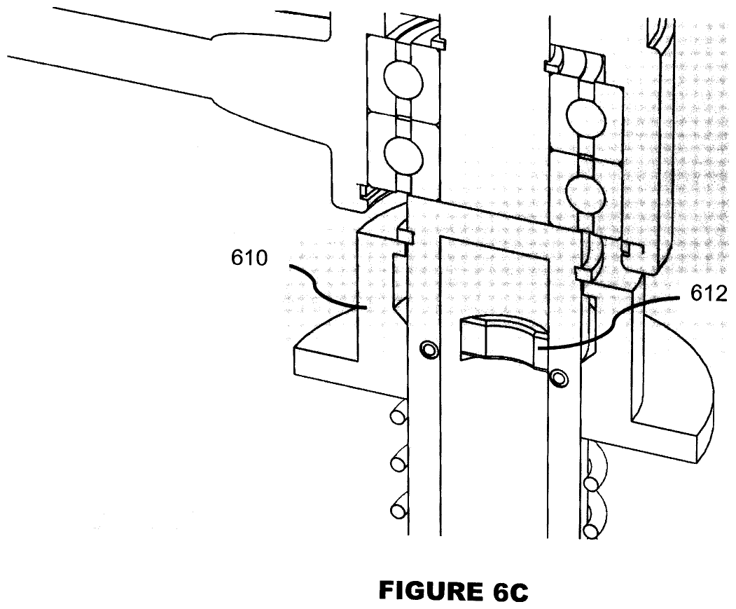

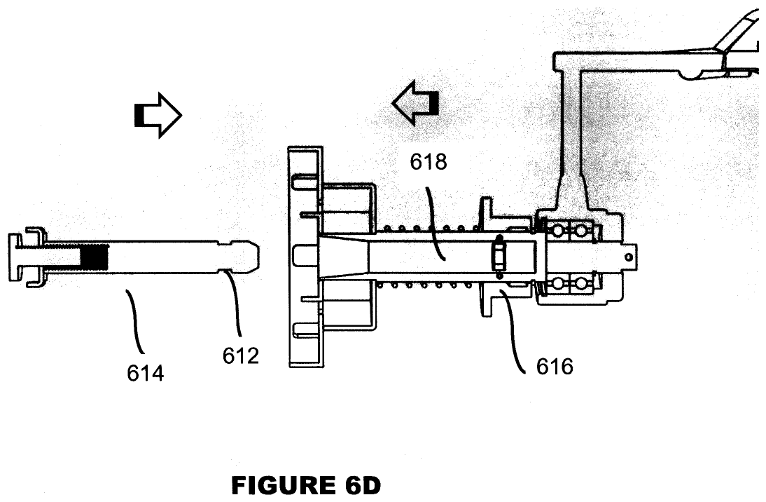

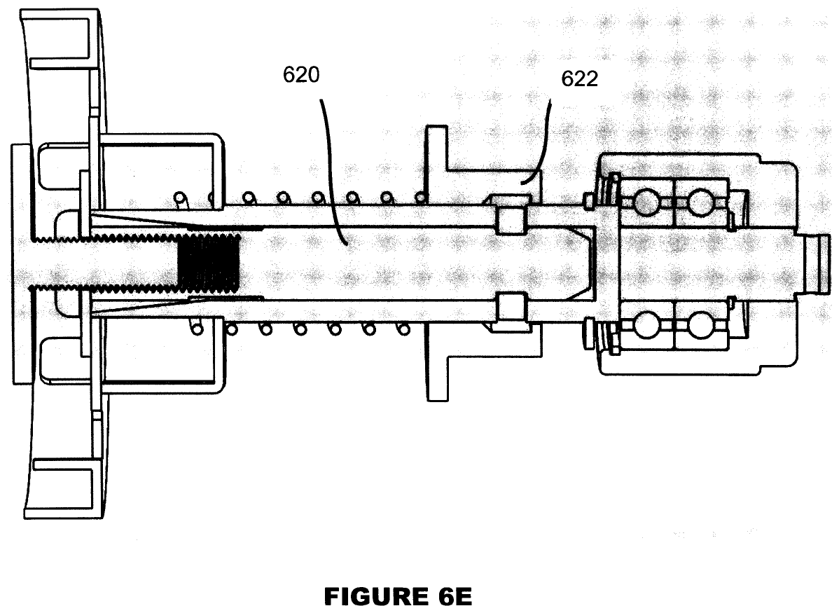

It will be appreciated that the principles and concepts of the present disclosure that are embodied in the foregoing examples may also be implemented in various structural and functional equivalent embodiments, some examples of which are described as herein. FIG. 6A illustrates an exploded view of a fourth embodiment of a female receptor (602) positioned circumference the hollow shaft (604) of the holder (606) in accordance of the present invention. It is preferably that the female receptor (602) is a housing with at least one curve key (608) circumference attached to the hollow shaft (604). FIG. 6B illustrates a perspective view of a fourth embodiment of a female receptor positioned circumference the hollow shaft of the holder in accordance of the present invention. FIG. 6C illustrates a cross-sectional view of a third embodiment of a female receptor positioned circumference the hollow shaft of the holder in accordance of the present invention. The arrangement of the female receptor such that the housing (610) having the curve keys (612) to form a core and key locking mechanism. FIG. 6D illustrates a quick-release mechanism configured for attaching a former to a holder and detaching the former from the holder via a core and key locking mechanism in accordance of the present invention. A circumference groove (612) near an end of the male connector (614) of the former is securely engaged and disengaged to the female receptor (616) positioned circumference the hollow shaft (618) of the holder via a core and key locking mechanism. FIG. 6E illustrates a close-up view of a quick-release mechanism configured for attaching a former to a holder via a core and key locking mechanism in accordance of the present invention. To attach the former to the holder, the male connector (620) of the former is pushed to the female receptor (622) positioned circumference of a hollow shaft of the holder for attaching the former to the holder via a locking mechanism. Meanwhile, to detach the former from the holder, force is exerted by pressing the female receptor (622) positioned of the hollow shaft of the holder towards a direction of the male connector (620) of the former. Subsequently, the male connector (620) of the former is pull from an opposite direction of the female receptor (622) positioned circumference of a hollow shaft of the holder for detaching the former from the holder.

In operation, the quick-release mechanism method of attaching a former to a holder and detaching the former from the holder for use in latex glove dipping process begins by providing a male connector of a former and a female receptor positioned circumference of a hollow shaft of the holder. Next, the male connector of the former is pushed to the female receptor positioned circumference of a hollow shaft of the holder for attaching the former to the holder via a locking mechanism. Then, for detaching the former from the holder, the female receptor positioned of the hollow shaft of the holder is pressed towards a direction of the male connector of the former. Subsequently, the male connector of the former is pull from an opposite direction of the female receptor positioned circumference of a hollow shaft of the holder for detaching the former from the holder.

The foregoing detailed description and examples are merely illustrative of the preferred embodiments. They are by no means meant to be the exclusive description of the inventive concept hereby disclosed. It will be recognized by one of ordinary skill in the art that certain aspects of the practice of the invention are readily susceptible to modification or practice by alternative, known means.

1. A former holder for use in latex glove dipping process comprising
a holder having
a roller disc coupled with an indexing cap;
a hollow shaft connected to an arm structure at one end and extended to the roller disc at another end;
a spring positioned around the hollow shaft;
characterized in that;
a former having a male connector;
a female receptor positioned circumference the hollow shaft of the holder;
such that a quick-release mechanism configured for attaching a former to a holder and detaching the former from the holder via a locking mechanism between the male connector of the former and the female receptor of the hollow shaft.

2. The former holder as claimed in claim 1 wherein the male connector is an extended elongated shaft from an end cuff portion of the former.

3. The former holder as claimed in claim 1 wherein the female receptor is a housing with at least one ball circumference attached to the hollow shaft allowing a circumference groove near an end of the male connector of the former securely engaged and disengaged to the female receptor positioned circumference the hollow shaft of the holder via a ball and sleeve locking mechanism.

4. The former holder as claimed in claim 1 wherein the female receptor is a housing with a spring and at least one curve pin circumference attached to the hollow shaft allowing a circumference groove near an end of the male connector of the former securely engaged and disengaged to the female receptor positioned circumference the hollow shaft of the holder via a spring and post detent locking mechanism.

5. The former holder as claimed in claim 1 wherein the female receptor is a housing and at least one curve pin circumference attached to the hollow shaft allowing a circumference groove near an end of the male connector of the former securely engaged and disengaged to the female receptor positioned circumference the hollow shaft of the holder via a clip and post detent locking mechanism.

6. The former holder as claimed in claim 1 wherein the female receptor is a housing with at least one curve key circumference attached to the hollow shaft allowing a circumference groove near an end of the male connector of the former securely engaged and disengaged to the female receptor positioned circumference the hollow shaft of the holder via a core and key locking mechanism.

7. A former holder for use in latex glove dipping process comprising
a holder having
a roller disc coupled with an indexing cap;
a hollow shaft connected to an arm structure at one end and extended to the roller disc at another end;
a spring positioned around the hollow shaft;
characterized in that;
a former having a male connector;
a female receptor positioned circumference the hollow shaft of the holder;
such that a quick-release mechanism configured for attaching a former to a holder and detaching the former from the holder via a ball and sleeve locking mechanism between the male connector of the former and the female receptor of the hollow shaft wherein the female receptor is a housing with at least one ball circumference attached to the hollow shaft allowing a circumference groove near an end of the male connector of the former securely engaged and disengaged to the female receptor positioned circumference the hollow shaft of the holder.

8. A former holder for use in latex glove dipping process comprising
a holder having
a roller disc coupled with an indexing cap;
a hollow shaft connected to an arm structure at one end and extended to the roller disc at another end;
a spring positioned around the hollow shaft;
characterized in that;
a former having a male connector;
a female receptor positioned circumference the hollow shaft of the holder;
such that a quick-release mechanism configured for attaching a former to a holder and detaching the former from the holder via a spring and post detent locking mechanism between the male connector of the former and the female receptor of the hollow shaft wherein the female receptor is a housing with a spring and at least one curve pin circumference attached to the hollow shaft allowing a circumference groove near an end of the male connector of the former securely engaged and disengaged to the female receptor positioned circumference the hollow shaft of the holder.

9. A former holder for use in latex glove dipping process comprising
a holder having
a roller disc coupled with an indexing cap;
a hollow shaft connected to an arm structure at one end and extended to the roller disc at another end;
a spring positioned around the hollow shaft;
characterized in that;
a former having a male connector;
a female receptor positioned circumference the hollow shaft of the holder;
such that a quick-release mechanism configured for attaching a former to a holder and detaching the former from the holder via a curve pin and post detent locking mechanism between the male connector of the former and the female receptor of the hollow shaft wherein the female receptor is a housing and at least one curve pin circumference is snap-fitted to the hollow shaft allowing a circumference groove near an end of the male connector of the former securely engaged and disengaged to the female receptor positioned circumference the hollow shaft of the holder.

10. A former holder for use in latex glove dipping process comprising
a holder having
a roller disc coupled with an indexing cap;
a hollow shaft connected to an arm structure at one end and extended to the roller disc at another end;
a spring positioned around the hollow shaft;
characterized in that;
a former having a male connector;
a female receptor positioned circumference the hollow shaft of the holder;
such that a quick-release mechanism configured for attaching a former to a holder and detaching the former from the holder via a core and key locking mechanism between the male connector of the former and the female receptor of the hollow shaft wherein the female receptor is a housing with at least one curve key circumference attached to the hollow shaft allowing a circumference groove near an end of the male connector of the former securely engaged and disengaged to the female receptor positioned circumference the hollow shaft of the holder.

11. A quick-release mechanism method of attaching a former to a holder and detaching the former from the holder for use in latex glove dipping process comprising
providing a male connector of a former;
providing a female receptor positioned circumference of a hollow shaft of the holder;
pushing the male connector of the former to the female receptor positioned circumference of a hollow shaft of the holder for attaching the former to the holder via a locking mechanism;
pressing the female receptor positioned of the hollow shaft of the holder towards a direction of the male connector of the former; and
pulling the male connector of the former from an opposite direction of the female receptor positioned circumference of a hollow shaft of the holder for detaching the former from the holder.

12. The quick-release mechanism method as claimed in claim 11 wherein the male connector is an extended elongated shaft from the former.

13. The quick-release mechanism method as claimed in claim 11 wherein the female receptor is a housing with at least one ball circumference attached to the hollow shaft allowing a circumference groove near an end of the male connector of the former securely engaged and disengaged to the female receptor positioned circumference the hollow shaft of the holder via a steel/plastic ball and sleeve locking mechanism.

14. The quick-release mechanism method as claimed in claim 11 wherein the female receptor is a housing with a spring and at least one curve pin circumference attached to the hollow shaft allowing a circumference groove near an end of the male connector of the former securely engaged and disengaged to the female receptor positioned circumference the hollow shaft of the holder via a spring and post detent locking mechanism.

15. The quick-release mechanism method as claimed in claim 11 wherein the female receptor is a housing and at least one curve pin circumference is snap-fitted to the hollow shaft allowing a circumference groove near an end of the male connector of the former securely engaged and disengaged to the female receptor positioned circumference the hollow shaft of the holder.

16. The quick-release mechanism method as claimed in claim 11 wherein the female receptor is a housing with at least one curve key circumference attached to the hollow shaft allowing a circumference groove near an end of the male connector of the former securely engaged and disengaged to the female receptor positioned circumference the hollow shaft of the holder via a core and key locking mechanism.

17. A former for use in latex glove dipping process comprising a male connector is extended from an end cuff portion of the former.

18. The former as claimed in claim 17 wherein the male connector is an extended elongated shaft from an end cuff portion of the former.

19. The former as claimed in claim 17 wherein the male connector is securely attached to the end cuff portion of the former via a retention plate with threaded screw mate and engage to an elongated shaft via another retention plate.

20. The former as claimed in claim 17 wherein the male connector is securely attached to the end cuff portion of the former having a prefabricated nut and allows the male connector to be fastened via a threaded fastener to the former.

21. The former as claimed in claim 17 wherein the male connector is securely attached to the end cuff portion of the former having a casting bolt into the former and allows the male connector to be fastened via a hollow internally threaded shaft to the former.
